(19) United States
(12) Patent Application Publication
(10) Pub. No.: US 2026/0368619 A1
(43) Pub. Date: Nov. 19, 2026

(54) DISCRETIZATION OF DRIFT DETECTION TO ANOMALY DETECTION

(71) Applicant: Red Hat, Inc., Raleigh, NC (US)

(72) Inventors: Robert Joao Geada, Newcastle upon Tyne (GB); Christina Xu, Boston, MA (US)

(21) Appl. No.: 19/208,220

(22) Filed: May 14, 2025

(51) Int. Cl. G06N 20/00

(52) U.S. Cl. CPC G06N 20/00

(57) ABSTRACT

A reference drift metric for a set of input data elements for a trained machine-learning model is computed based on a comparison between the set of input data elements and a set of reference data elements representative of training data used to train the trained machine-learning model. For each input data element, the input data element is modified to obtain a modified set of input data elements. For each input data element, a drift metric for the modified set of input data elements is computed based on a comparison between the modified set of input data elements and the set of reference data elements. For each input data element, a saliency score of a plurality of saliency scores is computed for the input data element based on a comparison between the drift metric and the reference drift metric. The plurality of saliency scores are output.

### BACKGROUND

Data analysis typically involves the application of statistical calculations or algorithms to sets of data. The statistical calculations and algorithms can identify trends in sets of data, select particular elements within a set of data, make predictions about future trends, etc. Some types of statistical calculations are performed to measure a degree of variance between a set of data elements and corresponding reference data elements. These techniques, which are generally referred to as “drift” detection techniques, are useful in determining whether a set of data being analyzed varies substantially from “reference” data typically expected in the same context. At a more granular level, anomaly detection techniques identify specific data points that vary from the reference data.

### SUMMARY

A drift detection technique can be used to compute a drift measurement between a set of input data elements and a set of reference data elements. A saliency algorithm can discretize the drift measurement to obtain a plurality of saliency scores for each data element in the set of input data elements. The saliency scores can be utilized to determine whether specific elements of the input data are anomalous (or not). In such fashion, implementations described herein enable anomaly detection for data elements without having to perform anomaly detection techniques for each element.

In one implementation, a method is provided. The method includes computing, by a computing system comprising one or more processor devices, a reference drift metric for a set of input data elements for a trained machine-learning model based on a comparison between the set of input data elements and a set of reference data elements representative of training data used to train the trained machine-learning model. The method includes, for each input data element of the set of input data elements, modifying the input data element to obtain a modified set of input data elements. The method further includes, for each input data element of the set of input data elements, computing a drift metric for the modified set of input data elements based on a comparison between the modified set of input data elements and the set of reference data elements. The method further includes, for each input data element of the set of input data elements, computing a saliency score of a plurality of saliency scores for the input data element based on a comparison between the drift metric and the reference drift metric, wherein the saliency score is indicative of a degree of salience between the input data element and the reference drift metric. The method further includes outputting the plurality of saliency scores.

In another implementation, a computing system is provided. The computing system includes a system memory, and one or more processor devices coupled to the memory. The one or more processor devices are to compute a reference drift metric for a set of input data elements for a trained machine-learning model based on a comparison between the set of input data elements and a set of reference data elements representative of training data used to train the trained machine-learning model. For each input data element of the set of input data elements, the one or more processor devices are to modify the input data element to obtain a modified set of input data elements. For each input data element of the set of input data elements, the one or more processor devices are further to compute a drift metric for the modified set of input data elements based on a comparison between the modified set of input data elements and the set of reference data elements. For each input data element of the set of input data elements, the one or more processor devices are further to, compute a saliency score of a plurality of saliency scores for the input data element based on a comparison between the drift metric and the reference drift metric, wherein the saliency score is indicative of a degree of salience between the input data element and the reference drift metric. The one or more processor devices are further to output the plurality of saliency scores.

In another implementation, a non-transitory computer-readable storage medium is provided. The non-transitory computer-readable storage medium includes executable instructions to cause one or more processor devices to compute a reference drift metric for a set of input data elements for a trained machine-learning model based on a comparison between the set of input data elements and a set of reference data elements representative of training data used to train the trained machine-learning model. For each input data element of the set of input data elements, the instructions cause the one or more processor devices to modify the input data element to obtain a modified set of input data elements. For each input data element of the set of input data elements, the instructions further cause the one or more processor devices to compute a drift metric for the modified set of input data elements based on a comparison between the modified set of input data elements and the set of reference data elements. For each input data element of the set of input data elements, the instructions further cause the one or more processor devices to compute a saliency score of a plurality of saliency scores for the input data element based on a comparison between the drift metric and the reference drift metric, wherein the saliency score is indicative of a degree of salience between the input data element and the reference drift metric. The instructions further cause the one or more processor devices to output the plurality of saliency scores.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a computing environment suitable for discretizing a drift calculation for a batch of data into a plurality of anomaly scores associated with the data elements in the batch of data according to some implementations of the present disclosure.

FIG. 2 is a data flow diagram for discretizing drift detection to detect anomalous data elements using the input saliency evaluation module of FIG. 1 according to some implementations of the present disclosure.

FIG. 3 is a flowchart illustrating operations performed by the computing system of FIG. 1 for discretizing a drift calculation for a batch of data into a plurality of anomaly scores according to one example.

FIG. 4 is a block diagram of the computing system of FIG. 1 for discretizing a drift calculation for a batch of data into a plurality of anomaly scores, according to one example.

FIG. 5 is a block diagram of the computing system suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Machine-learning models (MLMs) function to provide outputs by transforming, manipulating, or otherwise analyzing input data. MLMs can be trained as discriminative models and/or generative models. Discriminative models can be trained to classify inputs, identify trends, and perform other types of data analysis tasks. Generative models can be trained to generate various types of outputs. Whether a model is discriminative or generative, the corresponding output of a model (and the quality thereof) is strongly affected by the type of training data used to train the model. For example, assume that a healthcare data analysis model is trained using anonymized patient records from a varied cohort of patients equally distributed in a range from ages 18 – 80. Due to the wide variety of patient ages featured in the training data, the model is likely to exhibit strong performance for input records of patients within that age range.

Cutting edge MLMs are trained on large, varied corpuses of training data. However, in some instances, models can receive input data that varies significantly from the training data used to train the MLM. When a MLM processes input data that varies significantly from the training data used to train the MLM, the MLM is substantially more likely to produce an incorrect or low-quality output. To follow the previous example, the healthcare data analysis model would likely exhibit poor performance when analyzing a patient record for a three year old, as the model was not trained on patient records from patients of that age. As such, it is beneficial to identify whether a model input is statistically different from the training data used to train the model.

One technique to identify anomalous input data elements is drift detection. Drift detection is a coarse data analysis technique that compares large batches of input data to a corresponding batch of training data used to train the model. Drift detection is computationally inexpensive relative to anomaly detection, and can accurately identify whether a set of input data elements varies substantially from a representative batch of training data. However, conventional drift detection approaches fail to identify specific input data elements that vary from training data, which severely limits applicability to screening MLM inputs. Further, because training data for cutting-edge MLMs is usually considered confidential, drift detection is only applicable when the entity serving the model for inference has access to the training data used to train the model, which can be prohibitively restrictive.

Another technique to identify anomalous (i.e., inappropriate) input data elements is anomaly detection. Unlike drift detection, anomaly detection can identify discrete input data elements as anomalous by assigning an anomaly score to each data point of a dataset. However, anomaly detection techniques are substantially more expensive than drift detection techniques, and are considered prohibitively expensive to use for screening inputs to MLMs. Furthermore, like conventional drift detection approaches, anomaly detection requires access to a representative set of training data elements for a corresponding model. As such, like drift detection techniques, conventional anomaly detection techniques are generally inefficient for screening input data elements for MLMs. Thus, an approach to effectively and efficiently identify anomalous input data elements for MLMs is desired.

Accordingly, implementations described herein propose discretization of drift detection to anomaly detection. For example, assume that a set of input data elements is received at a computing system that serves a MLM, such as, for example a model server, a model serving instance, or the like. The computing system can compute a reference drift metric for the set of input data elements based on a set of reference data elements. The set of reference data elements can be training data elements used to train the model, or can be a set of reference data elements known to be representative of a typical problem domain. The computing system can compute a saliency output that includes a saliency score for each of the input data elements. The saliency scores can indicate a degree of salience between each data element and the reference drift metric.

To compute the saliency output, the computing system can modify a first input data element of the set of input data elements (e.g., replace the data element, remove the data element, etc.) to obtain a modified set of input data elements. The computing system can then compute a drift metric for the modified set of input data elements based on a comparison between the modified set of input data elements and the set of reference data elements. The computing system can compute a saliency score for the first input data element based on a comparison between the drift metric and the reference drift metric.

The computing system can repeat this process for each input data element in the set of input data elements. For example, once the saliency score is computed for the first input data element of the set, the computing system can revert the modification to the set of input data elements and modify a second input data element of the set to obtain a second modified set of input data elements. The second modified set of input data elements can be processed as described above to obtain a second saliency score for the second input data element. In such fashion, implementations described herein can calculate individual saliency scores for input data elements without needing to perform anomaly detection techniques, which can be prohibitively expensive, and without directly requiring representative training data for a particular model.

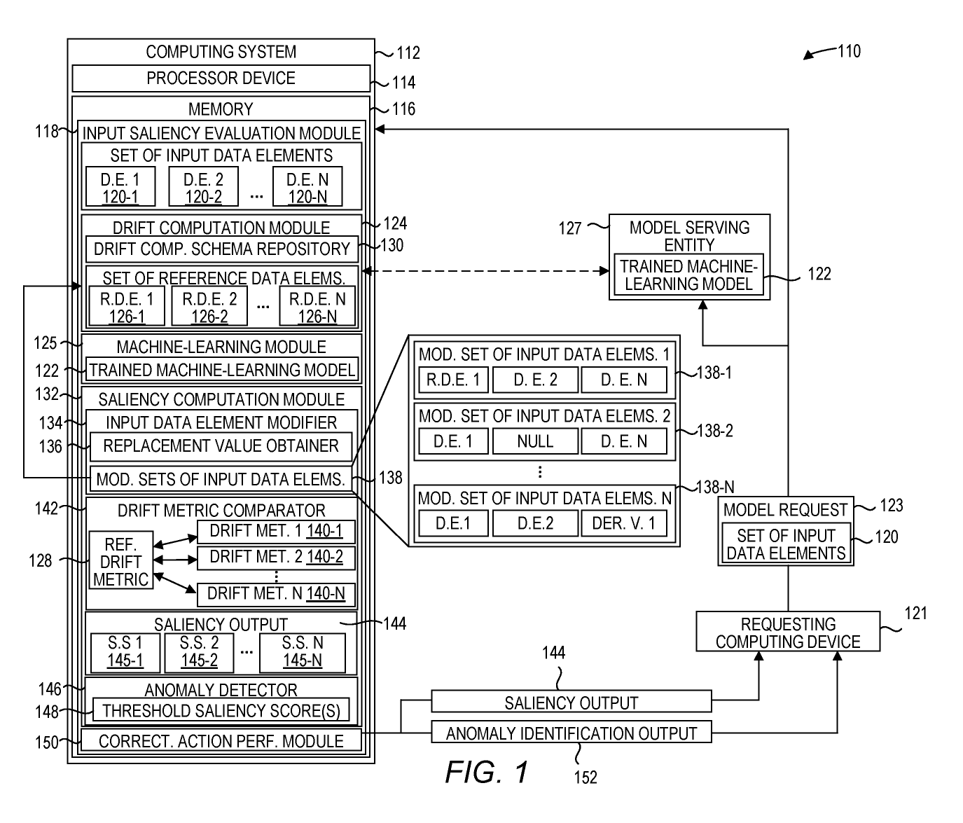

FIG. 1 is a block diagram of a computing environment suitable for discretizing a drift calculation for a batch of data into a plurality of anomaly scores associated with the data elements in the batch of data according to some implementations of the present disclosure. A computing environment 110 may include a computing system 112 with one or more processor device(s) 114 and a memory 116. As described herein, the “computing environment” 110 can be any type or manner of computing environment (e.g., a collection of computing devices, systems, and related infrastructure associated with a particular entity or organization), such as a “confidential” computing environment in which sensitive data and code is protected during processing, a “public” computing environment, etc. For example, the computing environment 110 can be or otherwise include a confidential computing “enclave” that leverages hardware-based TEEs and secure virtualization technologies, such as memory encryption, to isolate critical computations and prevent unauthorized access to data while in use. For another example, the computing environment 110 can be a distributed computing environment that utilizes computing resources across a variety of different types of devices (e.g., servers, virtualized devices, user devices, Internet-of-Things (IoT) devices, etc.).

The computing environment 110 can refer to a logical grouping, or clustering, of computing systems, devices, and/or resources. More specifically, the computing environment 110 is an environment in which a number of separate devices and/or systems share resources (e.g., hardware resources, compute cycles, services, etc.) via a central management framework that enforces consistent configuration and policies. It should be noted that the computing environment 110 can include any type or manner of computing device or system. For example, in some implementations, the computing environment 110 can include a number of quantum computing systems and classical computing systems.

The computing system 112 can operate in the computing environment 110. In some implementations, the computing system 112 may be a computing system that includes multiple computing devices (e.g., classical computing devices, quantum computing devices, etc.). Alternatively, in some implementations, the computing system 112 may be one or more computing devices within a computing system that includes multiple computing devices. Similarly, the processor device(s) 114 may include any computing or electronic device capable of executing software instructions to implement the functionality described herein.

The memory 116 can be or otherwise include any device(s) capable of storing data, including, but not limited to, volatile memory (random access memory, etc.), non-volatile memory, storage device(s) (e.g., hard drive(s), solid state drive(s), etc.). In some implementations, the memory 116 can include a containerized unit of software instructions (i.e., a “packaged container”). The containerized unit of software instructions can collectively form a container that has been packaged using any type or manner of containerization technique.

A containerized unit of software instructions can include one or more applications, and can further implement any software or hardware necessary for execution of the containerized unit of software instructions within any type or manner of computing environment. For example, the containerized unit of software instructions can include software instructions that contain or otherwise implement all components necessary for process isolation in any environment (e.g., the application, dependencies, configuration files, libraries, relevant binaries, etc.).

In some implementations, the computing environment 110 can include multiple types of nodes. As described herein, a “node” generally refers to a discrete unit of hardware and/or software resources. In some instances, nodes within the computing environment 110 can be configured to perform specific tasks. For example, some nodes within the computing environment 110 can be configured as “compute” or “processing” nodes that handle processing tasks or provide processing-heavy services. Compute nodes are generally allocated with hardware devices that can facilitate processing tasks, such as Graphics Processing Units (GPUs), Central Processing Units (CPUs), Application-specific Integrated Circuits (ASICs), Field-Programmable Gate Arrays (FPGAs), etc.

Conversely, storage nodes can be allocated with hardware devices to facilitate storage tasks, such as storage devices (e.g., hard drives, etc.), memory, high-bandwidth network devices, physical storage media, etc.). It should be noted that in some instances, storage nodes can include processing devices (e.g., CPUs, etc.) to facilitate storage operations (e.g., read/write operations) and processing nodes can include storage devices (e.g., random access memory) to facilitate processing operations.

In some implementations, the computing environment 110 can be, or otherwise include, a software development environment. The computing environment 110 can include computing device(s), system(s), etc. that are utilized for developing software. For example, the computing system 112 can be a system for creating (i.e., developing) and/or maintaining a large software project (e.g., an application. To do so, the computing system 112 may maintain a codebase for the large software project, a code versioning system and/or versioning information for the codebase, etc.

The memory 116 may include an input saliency evaluation module 118. The input saliency evaluation module 118 may function to compute and evaluate a plurality of saliency scores based on a given input (e.g., a set of data points to be processed using a machine-learning model (MLM)). More specifically, the input saliency evaluation module 118 can be utilized to compute a drift metric for a set of input data elements for a trained MLM. The drift metric can represent a degree of statistical “drift” between the set of input data elements and the data used to train the MLM. Based on the drift metric, the input saliency evaluation module 118 can generate a saliency score for each data element to identify which input data elements are particularly “salient” to the drift metric (i.e., causative). In other words, using the drift metric, the input saliency evaluation module 118 can discretize drift detection for anomaly detection to mitigate the deleterious effects of processing input datasets with a high degree of drift.

More specifically, the input saliency evaluation module 118 can obtain a set of input data elements 120-1 – 120-N (generally, set of input data elements 120). In some implementations, the set of input data elements 120 can be received from a requesting entity. For example, the input saliency evaluation module 118 can be a module in a model serving instance (e.g., a set of hardware and/or software resources configured to process received inputs with a MLM instance) that receives the set of input data elements 120 from a requesting computing device 121. The requesting computing device 121 may be a user device, a virtualized device, an automated service, etc.

In some implementations, the set of input data elements 120 can relate to a particular field, problem domain, industry, use-case, etc. For example, the set of input data elements can be temperature measurements from IoT devices, patient health metrics from a wide variety of patients, test scores from a wide variety of students, statistics associated with players of a particular sport, etc.

In some implementations, the set of input data elements 120 can be received within a model request 123. The model request 123 can be a request to process the set of input data elements with a trained MLM 122. The model request 123 may include the set of input data elements 120, along with an associated prompt, instructions, configuration information, etc. For example, the model request 123 may specify a particular mathematical technique or data analysis technique for a model to perform when processing the set of input data elements 120. In some implementations, the model request 123 can include instructions to evaluate whether any of the set of input data elements 120 differ substantially from the training data used to train the model used to process the model request 123.

The input saliency evaluation module 118 can include a machine-learning module 125. The machine-learning module 125 can be used by the input saliency evaluation module 118 to service the model request 123 received from the requesting computing device 121. To do so, the machine-learning module 125 can include a trained MLM 122. The trained MLM 122 can be, or otherwise include, any type or manner of machine-learning model(s) such as, for example, image recognition models, object detection models, world generation models, natural language processing models, learning object metadata models (LOM), large language models (LLMs), etc.

It should be noted that, although the trained MLM 122 is illustrated as being included in the input saliency evaluation module 118 (e.g., as part of a machine-learning module 125), in some instances, the trained MLM 122 can be located separately from the input saliency evaluation module 118. For example, the input saliency evaluation module 118 may be hosted on a virtualized device within a cloud computing environment while the trained MLM 122 is hosted on a different virtualized device (e.g., model serving entity 127) within the same environment. For another example, the input saliency evaluation module 118 may be a module implemented at the requesting computing device 121 to evaluate data elements prior to transmission to the computing system 112 (or some other model serving entity). In this manner, implementations described herein can further optimize computational resource usage by obviating unnecessary bandwidth expenditure associated with transmission of anomalous data elements.

It should be noted that the set of input data elements 120 may include any type or manner of data element, including raw data, structured data, particular formats of data (e.g., an audiovisual data element, a compressed data element, a character, a value, etc.), etc.

In some implementations, the machine-learning module 125 can be responsible for training the trained MLM 122. In other words, the machine-learning module 125 can be used to train the trained MLM 122 prior to receiving the model request 123. As such, in some implementations, the machine-learning module 125 can store data elements used for training of the trained MLM 122 to a data store, and can retrieve the stored data elements as necessary. The stored data elements can be used as a representational set of data elements to represent the “average” training data used to train the trained MLM 122.

The input saliency evaluation module 118 can include a drift computation module 124. The drift computation module 124 can determine a drift metric by comparing a received set of data elements to a stored set of data elements. For example, the drift computation module 124 can include a set of reference data elements 126-1 – 126-N (generally, set of reference data elements 126). The set of reference data elements 126 can represent the training data used to train the trained MLM 122. For example, if the trained MLM 122 is a classifier model trained to process financial records from retirees (e.g., those above the age of 65), the set of reference data elements 126 would likely include records for a representative variety of persons above the age of 65, and would likely not include records for persons below the age of 65. For another example, if the trained MLM 122 is trained to evaluate service access records to predict the occurrence of Distributed Denial of Service (DDOS) attacks using IoT devices, the set of reference data elements 126 would likely include a representative variety of service access records from IoT devices, and would likely not include records from non-IoT devices.

In some implementations, as described previously, the set of reference data elements 126 may have been used to train one or more trained MLMS (e.g., trained MLM 122). For example, prior to receipt of the model request 123, the machine-learning module 125 may perform a training iteration to train or fine-tune the trained MLM 122 using the set of reference data elements 126.

Additionally, or alternatively, in some implementations, the set of reference data elements 126 can include data elements output by the trained MLM 122. For example, the machine-learning module 125 can generate a prompt (i.e., prompt information) for the trained MLM 122 that instructs the trained MLM 122 to provide data elements used to train the trained MLM 122. Alternatively, the prompt may instruct the trained MLM 122 to generate new data elements representative of the data elements used to train the trained MLM 122 (e.g., in case the trained MLM 122 is trained to refrain from outputting training examples).

The drift computation module 124 can compute a reference drift metric 128 based on a comparison between the set of input data elements 120 and the set of reference data elements 126. The reference drift metric 128 can indicate a degree of “drift” or variance between the set of input data elements 120 and the set of reference data elements 126. In other words, the reference drift metric 128 can quantitatively indicate a degree of difference between the set of input data elements 120 and the set of reference data elements 126.

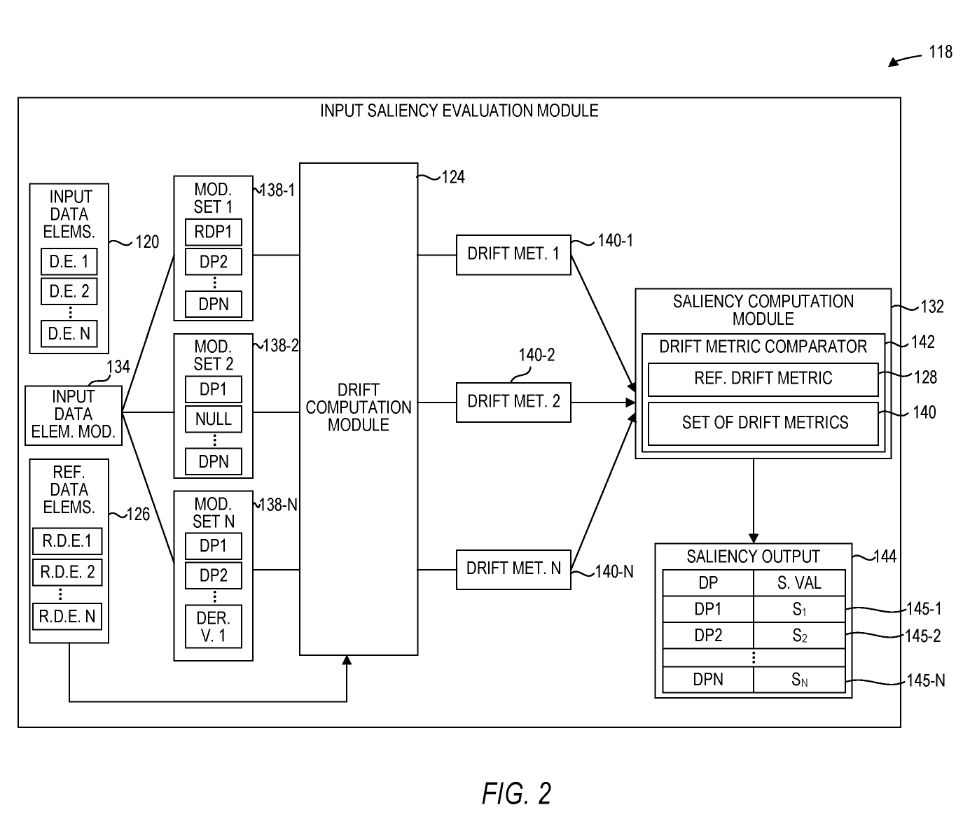

Once generated, the reference drift metric 128 may be stored for subsequent use. More specifically, the reference drift metric 128 can later be used to determine a degree of salience between each of the set of input data elements 120 and the reference drift metric 128. In other words, the reference drift metric 128 can be subsequently used to identify whether one (or more) of the set of input data elements 120 is “responsible” or causative of drift between the set of input data elements 120 and the set of reference data elements 126, as will be described in reference to FIG. 2 below.

In some implementations, the drift computation module 124 can include a drift computation schema repository 130 for computing the reference drift metric 128 (and any other drift metrics computed by the input saliency evaluation module 118). As described herein, a “drift computation schema” refers to an algorithm, technique, process, etc. for computing a degree of statistical “drift” between two sets of data elements. Examples of drift computation schemas include a Kolmogorov-Smirnov (KS) test, a Chi-Square Test, a population stability index, etc. The drift computation module 124 can select one (or more) of the drift computation schemas based on a variety of factors, such as current computational resource availability at the computing system 112, a predicted (or known) quantity of computational resources needed to execute a particular drift computation schema, an indication to use a particular schema included in the model request 123, etc.

The input saliency evaluation module 118 can include a saliency computation module 132. The saliency computation module 132 can perform computations using the reference drift metric 128 to evaluate a degree of salience between the set of input data elements 120 and the reference drift metric 128. For example, assume that the reference drift metric 128 indicates a high degree of statistical drift between the set of input data elements 120 and the set of reference data elements 126. Further assume that the input data element 120-1 varies substantially from the set of reference data elements 126, while the input data element 120-2 does not. In this instance, the salience score for the input data element 120-1 would be relatively high, as the input data element 120-1 is “salient” (i.e., causative, etc.) to the high degree of statistical drift indicated by the reference drift metric 128. Conversely, the salience score for the input data element 120-2 would be relatively low, as the input data element 120-2 is not particularly “salient” (i.e., causative, etc.) to the high degree of statistical drift indicated by the reference drift metric 128.

To do so, the saliency computation module 132 can modify an input data element of the set of input data elements 120 to obtain a modified set of input data elements. The saliency computation module can then measure a new drift metric based on a comparison between the modified set of input data elements and the set of reference data elements 126. Based on the difference between the newly generated drift metric and the reference drift metric 128, it can be inferred whether the value that was modified is salient to the reference drift metric 128. As such, in order to test how each input element affects the reference drift metric 128, the saliency computation module 132 can repeat this process for each of the set of input data elements 120 to create a plurality of modified sets of input data elements 138.

More specifically, the saliency computation module 132 may include an input data element modifier 134. The input data element modifier 134 can modify the input data element 120-1 of the set of input data elements 120 to obtain a corresponding modified set of input data elements 138-1. The input data element modifier 134 may then modify the input data element 120-2 to obtain a modified set of input data elements 138-2.

In some implementations, the input data element modifier 134 can include a replacement value obtainer 136 for modifying input data elements. The replacement value obtainer 136 can obtain replacement data elements and replace input data elements (e.g., from the set of input data elements 120) to obtain one of the modified sets of input data elements 138. For example, the replacement value obtainer 136 may obtain a replacement data element by selecting a reference data element from the set of reference data elements 126 to use as a replacement data element. For example, the replacement value obtainer 136 may randomly sample a reference data element from the set of reference data elements 126 and then replace a particular value from the set of input elements with the randomly sampled reference data element to obtain one of the modified sets of input data elements 138.

Additionally, or alternatively, in some implementations, rather than utilizing the replacement value obtainer 136 to replace a value in the set of input data elements 120, the input data element modifier 134 may obtain one of the modified sets of input data elements 138 by removing a corresponding input data element from the set of input data elements 120. As such, one of the modified sets of input data elements 138 may have one less input data element, and a new drift metric may be calculated based on the new number of input data elements.

For example, the input data element modifier 134 may obtain the modified set of input data elements 138-1 by replacing the input data element 120-1 with a replacement value. The input data element modifier 134 may then obtain the modified set of input data elements 138-2 by simply removing the data element 120-2 (or replacing with a NULL value). In such instances, the modified set of data elements 138-2 may include one less data element than the modified set of data elements 138-1.

It should be noted that a single input data element of the set of input data elements 120 can be modified by the input data element modifier 134 to obtain one of the modified sets of input data elements 138. Once an input data element of the set of input data elements 120 is modified to obtain one of the modified sets of input data elements 138, the modification can be reverted and the next input data element of the set of input data elements 120 can be modified to obtain a subsequent set of the modified sets of input data elements 138. To follow the previous example, when the input data element 120-2 is removed to create the modified set of input data elements 138-2, the modification made to the input data element 120-1 is not included in the modified set of input data elements 138-2. Rather, the modified set of input data elements 138-2 includes the original input data element 120-1, rather than the modified version included in the modified set of input data elements 138-1.

Additionally, or alternatively, in some implementations, the replacement value obtainer 136 can obtain a derived value to use as a replacement. The derived value may be a new value derived from the set of reference data elements 126 using some statistical or mathematical process. For example, the derived value may be an average value of the set of reference data elements 126. For another example, the derived value may be a median value of the set of reference data elements 126. For yet another example, the derived value may be derived or otherwise calculated such that the derived value is descriptive of the set of reference data elements 126. The derived value may be calculated by the replacement value obtainer 136 or may be calculated elsewhere and received by the replacement value obtainer 136.

Each of the set of input data elements 120 can be modified by the input data element modifier 134 to obtain a corresponding set of the modified sets of input data elements 138. To follow the illustrated example, the first modified set of input data elements 138-1 may be created by replacing the first input data element 120-1 (D. E. 1) with the first reference data element 126-1 (R. D. E. 1). The second modified set of input data elements 138-2 may be created by removing the second data element 120-2 (D. E. 2) from the set of input data elements 120. As such, the second modified set of input data elements 138-2 may include one less data element than the first modified set of input data elements 138-1. An Nth modified set of input data elements 138-N, with N being equal to the number of data elements in the set of input data elements 120, may be created by replacing the Nth data element 120-N (D. E. N) with a derived value (DER. V. 1) calculated from the set of reference data elements 126.

It should be noted that the plurality of modified sets of input data elements 138, as seen in FIG. 1, merely illustrate different approaches for replacing elements of the set of input data elements 120. In some implementations, the same technique to modify an input data element to create a modified set of input data elements can be utilized to create each of the modified sets of input data elements 138. For example, the first reference data element 126-1 can replace the input data element 120-1 in the first modified set of input data elements 138-1, the first reference data element 126-1 (or some other reference data element) can also replace the input data element 120-2 in the second modified set of input data elements 138-2, etc. For another example, the input data element 120-1 can be dropped (or replaced with a NULL value) to create the first modified set of input data elements 138-1, the input data element 120-2 can be dropped to create the second modified set of input data elements 138-2, etc.

Alternatively, in some implementations, a combination of approaches and replacement values may be utilized to produce the modified sets of input data elements 138. To follow the example illustrated in FIG. 1, the input data element 120-1 can be replaced with the reference data element 126-1 to create the modified set of input data elements 138-1, the input data element 120-2 can be dropped to create the modified set of input data elements 138-2, the input data element 120-N can be replaced with a derived data element (e.g., a mean of the set of reference data elements 126, etc.) to create the modified set of input data elements 138-N, etc.

The drift computation module 124 may further compute a set of drift metrics 140-1 – 140-N (generally drift metrics 140). The set of drift metrics 140 may be computed based on the modified sets of input data elements 138. More specifically, to compute the set of drift metrics 140, the drift computation module 124 can evaluate a difference between each of the modified sets of input data elements 138 and the set of reference data elements 126. For example, the drift computation module 124 can compute the drift metric 140-1 by evaluating a degree of drift between the set of reference data elements 126 and the modified set of input data elements 138-1. The drift computation module 124 can then compute the drift metric 140-2 by evaluating a degree of drift between the set of reference data elements 126 and the modified set of input data elements 138-2.

Each of the set of drift metrics 140 can indicate a degree of drift between one of the modified sets of input data elements 138 and the set of reference data elements 126. For example, drift metric 140-1 may quantitatively describe a difference between the first modified set of input data elements 138-1 and the set of reference data elements 126. The drift metric 140-2 may quantitatively describe a difference between the second modified set of input data elements 138-2 and the set of reference data elements 126. Additionally, the drift metric 140-N may quantitatively describe a difference between the Nth modified set of input data elements 138-N and the set of reference data elements 126.

The saliency computation module 132 may include a drift metric comparator 142. The drift metric comparator 142 may compare the reference drift metric 128 to the set of drift metrics 140 calculated from the modified sets of input data elements 138. For example, the first drift metric 140-1 may be compared to the reference drift metric 128 in order to determine the difference between the first drift metric 140-1 and the reference drift metric 128. The second drift metric 140-2 may be compared to the reference drift metric 128 in order to determine the difference between the second drift metric 140-2 and the reference drift metric 128. Additionally, the Nth drift metric 140-N may be compared to the reference drift metric 128 in order to determine the difference between the Nth drift metric 140-N and the reference drift metric 128.

Based on the comparisons between the reference drift metric 128 and each of the set of drift metrics 140, the drift metric comparator 142 can generate a saliency output 144. The saliency output 144 can include a plurality of saliency scores 145-1 - 145-N (generally saliency scores 145). Each of the saliency scores 145 can be determined based on the comparison between one of the set of drift metrics 140 and the reference drift metric 128. Thus, each of the saliency scores 145 can be associated with a particular set of the modified sets of input data elements 138, and each of the modified sets of input data elements 138 can be associated with a particular input data element from the set of input data elements 120. For example, the first saliency score 145-1 is calculated based on the first drift metric 140-1. The first drift metric 140-1 is calculated based on a comparison between the first modified set of input data elements 138-1 and the set of reference data elements 126. The first modified set of input data elements 138-1 is created by modifying the first input data element 120-1 of the set of input data elements 120. Thus, the first saliency score 145-1 is reflective of how modifying the first input data element 120-1 impacts the reference drift metric 128.

For a more specific example, turning to FIG. 2, FIG. 2 is a data flow diagram for discretizing drift detection to detect anomalous data elements using the input saliency evaluation module of FIG. 1 according to some implementations of the present disclosure. More specifically, the input saliency evaluation module 118 can obtain the set of input data elements 120 and the set of reference data elements 126. For example, the set of input data elements 120 may be provided to the input saliency evaluation module 118 from a user computing device. For another example, the set of input data elements 120 may be provided to the input saliency evaluation module 118 from a machine-learning model, an automated service, etc.

In some implementations, the set of reference data elements 126 can be obtained by the input saliency evaluation module 118 from one or more sets of training data (e.g., a set of training data previously used to train the trained MLM 122, a set of training data used to train a model known to be analogous to the trained MLM, etc.). Additionally, or alternatively, in some implementations, the set of reference data elements 126 can be obtained from one or more data repositories. For example, the set of reference data elements 126 can be obtained from a data repository associated with an entity (e.g., an organization, a service provider, etc.) that trained the trained MLM 122. For another example, the set of reference data elements 126 can be obtained from a data repository associated with a public training dataset. The set of input data elements 120 and the set of reference data elements 126 can be obtained and provided to the drift computation module 124.

Additionally, or alternatively, the set of input data elements 120 and set of reference data elements 126 may be retrieved by the drift computation module 124 (e.g., by accessing one or more storage areas of memory 116, etc.). The drift computation module 124 may compare the set of input data elements 120 and the set of reference data elements 126 to determine a reference drift metric 128. In some examples, the drift computation module 124 may compute the reference drift metric 128 using a drift computation schema from the drift computation schema repository 130.

In some implementations, the set of input data elements 120 can be formatted such that a drift computation schema cannot be effectively applied to the set of input data elements 120. In such instances, an MLM may transform the set of input data elements 120 into a format that is similar to, or the same as, the set of reference data elements 126. For example, the set of input data elements 120 may be of a particular data type different than the set of reference data elements 126, and the input saliency evaluation module 118 can transform the set of input data elements 120 to the data type of the set of reference data elements 126 (or vice-versa). For example, the input saliency evaluation module 118 can transform a visual data element (e.g., an image) into a numerical data element (e.g., using a machine-learning model, etc.).

The input data element modifier 134 can generate the modified sets of input data elements 138-1, 138-2, and 138-N as described with regards to FIG. 1. The drift computation module can respectively generate the drift metrics 140-1, 140-2, and 140-N for the modified sets of input data elements 138-1, 138-2, and 138-N. Each of the set of drift metrics 140 can indicate a degree of drift between each of the modified sets of input data elements 138 and the set of reference data elements 126. For example, the drift metric 140-1 can represent a degree of drift between the modified set of input data elements 138-1 and the set of reference data elements 126.

The set of drift metrics 140 can be processed using the saliency computation module 132. More specifically, the saliency computation module 132 can include a drift metric comparator 142. The drift metric comparator 142 can compare the set of drift metrics 140 to the reference drift metric 128. If one of the set of drift metrics 140 is substantially different than the reference drift metric 128, the drift metric comparator 142 can indicate that one of the modified sets of input data elements 138 associated with the substantially different drift metric may have replaced an anomalous input data element.

Because the modified sets of input data elements 138 are generated by replacing a particular value with an “average” value that is unlikely to cause drift (i.e., is unlikely to be an anomalous data element) or is dropped entirely, if one of the set of drift metrics 140 for one of the modified sets of input data elements 138 is substantially lower than the reference drift metric 128, it can be inferred that the input data element replaced (or dropped) to create one of the modified sets of input data elements 138 is causative of the drift between the set of input data elements 120 and the set of reference data elements 126.

For example, assume that the reference drift metric 128 that measures drift between the set of input data elements 120 and the set of reference data elements 126 indicates a high degree of drift. Further assume that this high degree of drift is caused by the input data element 120-2 (i.e., the input data element 120-2 is anomalous). The modified set of input data elements 138-1 is created by replacing the input data element 120-1 with the reference data element 126-1. However, because the input data element 120-2 is still present in the modified set of input data elements 138-1, the drift metric 140-1 is likely to be similar to the reference drift metric 128. Next, the modified set of input data elements 138-2 is created by replacing the input data element 120-2 with the reference data element 126-2. In this instance, because the input data element 120-2 is no longer present in the modified set of input data elements 138-1, the drift metric 140-2 is likely to be substantially less than the reference drift metric 128.

Based on this difference, the saliency computation module 132 can identify the input data element 120-2 as being anomalous. The saliency computation module 132 can further identify the input data element 120-2 as being highly salient to the reference drift metric 128. More specifically, because the input data element 120-2 is anomalous and the input data element 120-1 is non-anomalous, the saliency output 144 generated by the saliency computation module 132 can indicate a high degree of salience for the input data element 120-2, while indicating a lesser degree of salience for the input data element 120-1.

Returning to FIG. 1, the saliency computation module 132 can include an anomaly detector 146. The anomaly detector 146 can access the saliency output 144 to analyze the plurality of saliency scores 145. For example, the anomaly detector 146 can analyze the plurality of saliency scores 145 by comparing each saliency score of the plurality of saliency scores 145 to a threshold saliency score 148. If a first analyzed saliency score 145-1 of the plurality of saliency scores 145 is greater than the threshold saliency score 148, the anomaly detector 146 may identify the input data element corresponding to the first analyzed saliency score 145-1 as anomalous. If the first analyzed saliency score 145-1 is less than or equal to the threshold saliency score 148, the anomaly detector 146 may identify the input data element corresponding to the first analyzed saliency score 145-1 as non-anomalous.

The input saliency evaluation module 118 may include a corrective action performance module 150. The corrective action performance module 150 may determine whether a corrective action is necessary, and if so, the corrective action performance module 150 can select a corrective action to perform. For example, if a saliency score of the plurality of saliency scores 145 of the saliency output 144 is determined to be greater than the threshold saliency score 148, the corrective action performance module 150 may determine that a corrective action should be performed.

In some implementations, the corrective action performance module 150 may remove the input data element from the set of input data elements 120. Additionally, or alternatively, the corrective action performance module 150 may replace the input data element with a corrective value. The corrective value may be a reference data element from the set of reference data elements 126, a predetermined value, some derived value determined from the set of input data elements 120 or the set of reference data elements 126, etc. For example, the corrective action performance module 150 may derive the value by applying a smoothing function to the set of input elements to obtain a derived value.

In some implementations, the set of input data elements 120 can be processed or otherwise used to complete various task(s) after (or concurrently with) performance of a corrective action. Specifically, in some implementations, the set of input data elements 120 can be processed with the trained MLM 122 to generate an output. For example, the set of input data elements 120 may be modified to replace an identified anomalous value with a replacement value. The set of input data elements 120 can then be processed with the trained MLM 122 at inference to generate an output.

Additionally, or alternatively, in some implementations, the set of input data elements 120 may be processed with the trained MLM 122 to generate a training output. The training output can then be evaluated with a loss function to train the trained MLM 122. For example, the training output may be generated as part of a fine-tuning training process to fine-tune the trained MLM 122 with additional training iterations. For another example, the training output may be generated as part of a reinforcement learning process that optimizes the trained MLM 122 with reinforcement learning feedback.

Alternatively, in some implementations, the corrective action performance module 150 can determine that no corrective action is necessary. For example, the corrective action performance module 150 can determine that no corrective action is necessary if a ratio of anomalous input data elements to non-anomalous input data elements was relatively low (e.g., 1 anomalous input data element to 10,000 non-anomalous input data elements, etc.). Additionally, or alternatively, the corrective action performance module 150 can determine that no corrective action is necessary if a saliency score of the plurality of saliency scores 145 is greater than the threshold saliency score 148, but less than a second threshold saliency score.

In some embodiments, the corrective action performance module 150 may generate and send an anomaly identification output 152. The anomaly identification output 152 may identify which input data elements from the set of input data elements 120 are determined to be anomalous. The anomaly identification output 152 may visually indicate that one or more input data elements from the set of input data elements 120 are anomalous. For example, the anomaly identification output 152 may alter a text color of one or more anomalous input data elements of the set of input data elements 120, such that the anomalous input data elements are visually different from non-anomalous input data elements. Additionally, or alternatively, the anomaly identification output 152 may provide a graphic (e.g., such as a red warning graphic) that identifies the one or more anomalous input data elements.

In some implementations, the anomaly identification output 152 may be provided to the requesting computing device 121 alongside the saliency output 144 (e.g., such as within the same output or message). Additionally, or alternatively, the anomaly identification output 152 may be provided to the requesting computing device 121 independently from the saliency output 144 (e.g., such as a separate output or message).

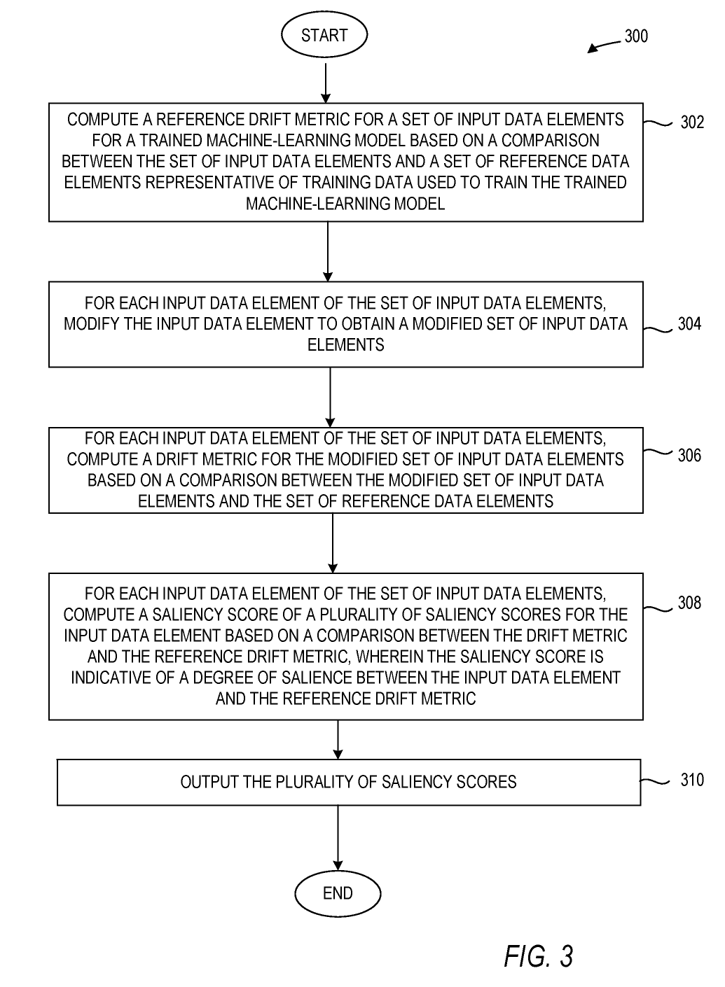

FIG. 3 is a flowchart illustrating operations performed by the computing system of FIG. 1 for discretizing a drift calculation for a batch of data into a plurality of anomaly scores according to one example. Elements of FIG. 1 are referenced in describing FIG. 3 for the sake of clarity. In FIG. 3, operations 300 begin with a processor device of a computing device, computing system, network node, etc., such as the processor device(s) 114 of the computing system 112 of FIG. 1. The processor device(s) 114 are to compute a reference drift metric 128 for a set of input data elements 120 for a trained machine-learning model 122 based on a comparison between the set of input data elements 120 and a set of reference data elements 126 representative of training data used to train the trained machine-learning model 122 (block 302). For each input data element of the set of input data elements 120, the processor device(s) 114 are to modify the input data element to obtain a modified set of input data elements 138 (block 304). For each input data element of the set of input data elements 120, the processor device(s) 114 are further to compute a drift metric 140 for the modified set of input data elements 138 based on a comparison between the modified set of input data elements 138 and the set of reference data elements 126 (block 306). For each input data element of the set of input data elements 120, the processor device(s) 114 are further to compute a saliency score of a plurality of saliency scores 145 for the input data element based on a comparison between the drift metric 140 and the reference drift metric 128, wherein the saliency score is indicative of a degree of salience between the input data element and the reference drift metric 128 (block 308). The processor device(s) 114 are further to output the plurality of saliency scores 145 (block 310).

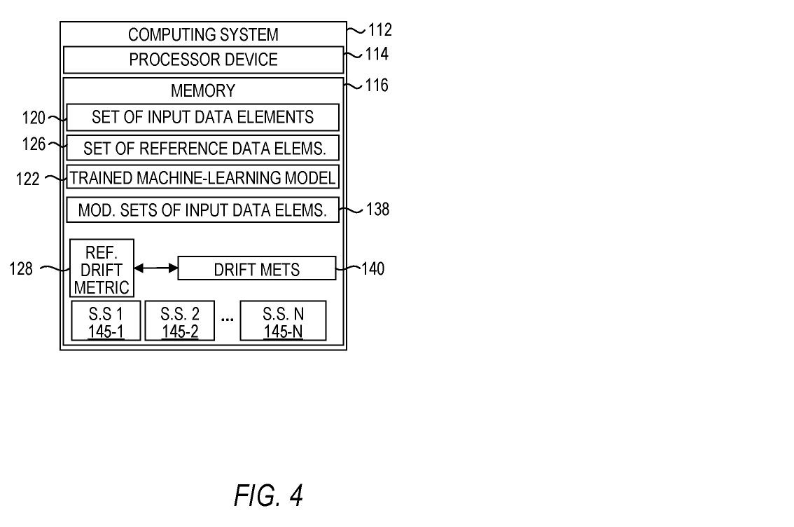

FIG. 4 is a block diagram of the computing system of FIG. 1 for discretizing a drift calculation for a batch of data into a plurality of anomaly scores, according to one example. Elements of FIG. 1 are referenced in describing FIG. 4 for the sake of clarity. In the example of FIG. 4, the computing system 112 includes a memory 116 and processor device(s) 114 coupled to the memory 116. The processor device(s) 114 are to compute a reference drift metric 128 for a set of input data elements 120 for a trained machine-learning model 122 based on a comparison between the set of input data elements 120 and a set of reference data elements 126 representative of training data used to train the trained machine-learning model 122. For each input data element of the set of input data elements 120, the processor device(s) 114 are to modify the input data element to obtain a modified set of input data elements 138. For each input data element of the set of input data elements 120, the processor device(s) 114 are further to compute a drift metric 140 for the modified set of input data elements 138 based on a comparison between the modified set of input data elements 138 and the set of reference data elements 126. For each input data element of the set of input data elements 120, the processor device(s) 114 are further to compute a saliency score of a plurality of saliency scores 145 for the input data element based on a comparison between the drift metric 140 and the reference drift metric 128, wherein the saliency score is indicative of a degree of salience between the input data element and the reference drift metric 128. The processor device(s) 114 are further to output the plurality of saliency scores 145.

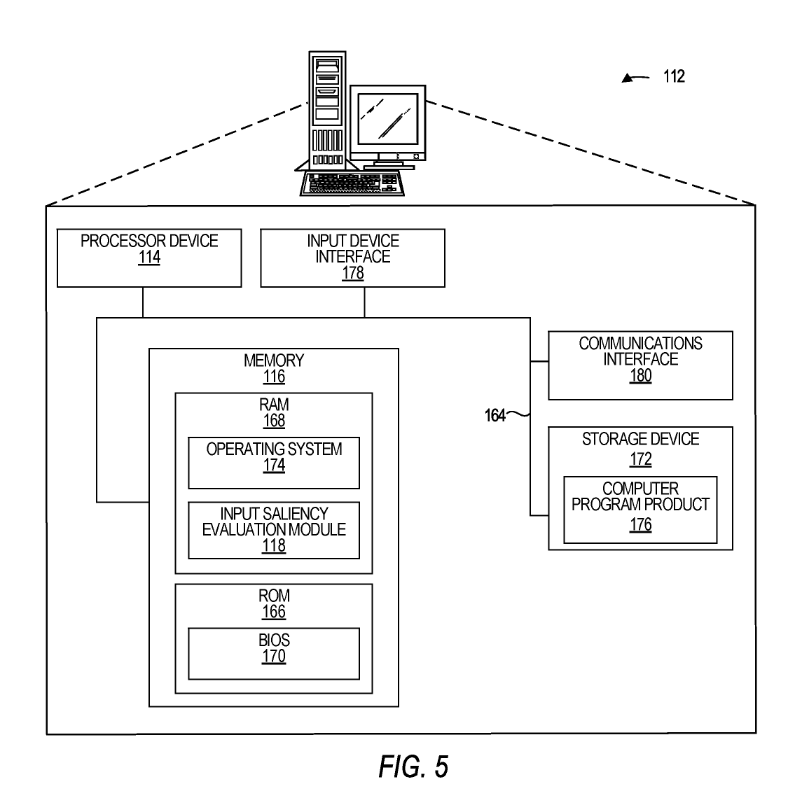

FIG. 5 is a block diagram of the computing system 112 suitable for implementing examples according to one example. The computing system 112 may comprise any computing or electronic device capable of including firmware, hardware, and/or executing software instructions to implement the functionality described herein, such as a computer server, a desktop computing device, a laptop computing device, a smartphone, a computing tablet, or the like. The computing system 112 includes the processor device(s) 114, the memory 116, and a system bus 164. The system bus 164 provides an interface for system components including, but not limited to, the memory 116 and the processor device(s) 114. The processor device(s) 114 can be any commercially available or proprietary processor.

The system bus 164 may be any of several types of bus structures that may further interconnect to a memory bus (with or without a memory controller), a peripheral bus, and/or a local bus using any of a variety of commercially available bus architectures. The memory 116 may include non-volatile memory 166 (e.g., read-only memory (ROM), erasable programmable read-only memory (EPROM), electrically erasable programmable read-only memory (EEPROM), etc.), and volatile memory 168 (e.g., random-access memory (RAM)). A basic input/output system (BIOS) 170 may be stored in the non-volatile memory 166 and can include the basic routines that help to transfer information between elements within the computing system 112. The volatile memory 168 may also include a high-speed RAM, such as static RAM, for caching data.

The computing system 112 may further include or be coupled to a non-transitory computer-readable storage medium such as the storage device 172, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 172 and other drives associated with computer-readable media and computer-usable media may provide non-volatile storage of data, data structures, computer-executable instructions, and the like.

A number of modules can be stored in the storage device 172 and in the volatile memory 168, including an operating system 174 and one or more program modules, such as the input saliency evaluation module 118, which may implement the functionality described herein in whole or in part. All or a portion of the examples may be implemented as a computer program product 176 stored on a transitory or non-transitory computer-usable or computer-readable storage medium, such as the storage device 172, which includes complex programming instructions, such as complex computer-readable program code, to cause the processor device(s) 114 to carry out the steps described herein. Thus, the computer-readable program code can comprise software instructions for implementing the functionality of the examples described herein when executed on the processor device(s) 114. The processor device(s) 114, in conjunction with the input saliency evaluation module 118 in the volatile memory 168, may serve as a controller, or control system, for the computing system 112 that is to implement the functionality described herein.

Because the input saliency evaluation module 118 is a component of the computing system 112, functionality implemented by the input saliency evaluation module 118 may be attributed to the computing system 112 generally. Moreover, in examples where the input saliency evaluation module 118 comprises software instructions that program the processor device(s) 114 to carry out functionality discussed herein, functionality implemented by the input saliency evaluation module 118 may be attributed herein to the processor device(s) 114.

An operator, such as a user, may also be able to enter one or more configuration commands through a keyboard (not illustrated), a pointing device such as a mouse (not illustrated), or a touch-sensitive surface such as a display device. Such input devices may be connected to the processor device(s) 114 through an input device interface 178 that is coupled to the system bus 164 but can be connected by other interfaces such as a parallel port, an Institute of Electrical and Electronic Engineers (IEEE) 1394 serial port, a Universal Serial Bus (USB) port, an IR interface, and the like. The computing system 112 may also include the communications interface 180, such as an Ethernet transceiver and/or a Wi-Fi transceiver, or the like, suitable for communicating with a network as appropriate or desired. The computing system 112 may also include a video port configured to interface with the display device, to provide information to the user.

Individuals will recognize improvements and modifications to the preferred examples of the disclosure. All such improvements and modifications are considered within the scope of the concepts disclosed herein and the claims that follow.

What is claimed is:

1. A method, comprising:
computing, by a computing system comprising one or more processor devices, a reference drift metric for a set of input data elements for a trained machine-learning model based on a comparison between the set of input data elements and a set of reference data elements representative of training data used to train the trained machine-learning model;
for each input data element of the set of input data elements:
modifying the input data element to obtain a modified set of input data elements;
computing a drift metric for the modified set of input data elements based on a comparison between the modified set of input data elements and the set of reference data elements; and
computing a saliency score of a plurality of saliency scores for the input data element based on a comparison between the drift metric and the reference drift metric, wherein the saliency score is indicative of a degree of salience between the input data element and the reference drift metric; and
outputting the plurality of saliency scores.

2. The method of claim 1, wherein, prior to computing the reference drift metric, the method comprises:
training the trained machine-learning model using the set of reference data elements.

3. The method of claim 1, wherein modifying the input data element comprises:
replacing the input data element with a new value.

4. The method of claim 3, wherein replacing the input data element with the new value comprises:
computing the new value based on an average value of the set of reference data elements.

5. The method of claim 3, wherein replacing the input data element with the new value comprises:
selecting the new value from the set of reference data elements.

6. The method of claim 1, wherein modifying the input data element comprises:
removing the input data element from the set of input data elements.

7. The method of claim 1, further comprising:
determining that each of the plurality of saliency scores is less than a threshold saliency score; and
providing, for output, information indicating that each input data element of the set of input data elements is non-anomalous.

8. The method of claim 1, further comprising:
making a determination that a first saliency score of the plurality of saliency scores is greater than a threshold saliency score, wherein the first saliency score corresponds to a first input data element of the set of input data elements; and
responsive to the determination, identifying the first input data element as an anomalous data element.

9. The method of claim 8, wherein the method further comprises:
performing a corrective action for the anomalous data element.

10. The method of claim 9, wherein performing the corrective action for the anomalous data element comprises:
removing the anomalous data element from the set of input data elements.

11. The method of claim 9, wherein performing the corrective action for the anomalous data element comprises:
replacing the anomalous data element with an average value of the set of reference data elements.

12. The method of claim 9, wherein performing the corrective action for the anomalous data element comprises:
applying a smoothing function to the set of input data elements.

13. The method of claim 9, wherein performing the corrective action for the anomalous data element comprises:
generating, for display, an anomaly identification output indicating that the first input data element is the anomalous data element.

14. A computing system comprising:
a system memory; and
one or more processor devices communicatively coupled to the system memory, the one or more processor devices to:
compute a reference drift metric for a set of input data elements for a trained machine-learning model based on a comparison between the set of input data elements and a set of reference data elements representative of training data used to train the trained machine-learning model;
for each input data element of the set of input data elements:
modify the input data element to obtain a modified set of input data elements;
compute a drift metric for the modified set of input data elements based on a comparison between the modified set of input data elements and the set of reference data elements; and
compute a saliency score of a plurality of saliency scores for the input data element based on a comparison between the drift metric and the reference drift metric, wherein the saliency score is indicative of a degree of salience between the input data element and the reference drift metric; and
output the plurality of saliency scores.

15. The computing system of claim 14, wherein, prior to computing the reference drift metric, the one or more processor devices are to:
train the trained machine-learning model using the set of reference data elements.

16. The computing system of claim 14, wherein, to modify the input data element, the one or more processor devices are to:
replace the input data element with a new value.

17. The computing system of claim 16, wherein to replace the input data element with the new value, the one or more processor devices are to:
compute the new value based on an average value of the set of reference data elements.

18. A non-transitory computer-readable storage medium that includes executable instructions configured to cause one or more processor devices to:
compute a reference drift metric for a set of input data elements for a trained machine-learning model based on a comparison between the set of input data elements and a set of reference data elements representative of training data used to train the trained machine-learning model;
for each input data element of the set of input data elements:
modify the input data element to obtain a modified set of input data elements;
compute a drift metric for the modified set of input data elements based on a comparison between the modified set of input data elements and the set of reference data elements; and
compute a saliency score of a plurality of saliency scores for the input data element based on a comparison between the drift metric and the reference drift metric, wherein the saliency score is indicative of a degree of salience between the input data element and the reference drift metric; and
output the plurality of saliency scores.

19. The non-transitory computer-readable storage medium of claim 18, wherein, prior to computing the reference drift metric, the instructions further cause the one or more processor devices to:
train the trained machine-learning model using the set of reference data elements.

20. The non-transitory computer-readable storage medium of claim 18, wherein, to modify the input data element, the instructions further cause the one or more processor devices to:
replace the input data element with a new value.
